(19) United States
(12) Patent Application Publication
(10) Pub. No.: US 2022/0176843 A1
(43) Pub. Date: Jun. 9, 2022

(54) METHOD AND DEVICE FOR SUPPLYING ELECTRIC POWER OF ELECTRIC VEHICLE

(71) Applicants: HYUNDAI MOTOR COMPANY, Seoul (KR); KIA CORPORATION, Seoul (KR)

(72) Inventor: Kyu Beom Ko, Incheon (KR)

(21) Appl. No.: 17/473,981

(22) Filed: Sep. 13, 2021

(30) Foreign Application Priority Data
Dec. 4, 2020 (KR) 10-2020-0168745

(51) Int. Cl. B60L 53/66; B60L 58/12; B60L 53/62; H02J 7/00

(52) U.S. Cl. CPC B60L 53/665; B60L 58/12; H02J 7/00032; H02J 7/0048; B60L 53/62

(57) ABSTRACT

Disclosed is a method for supplying electric power of an electric vehicle, which includes when an operation mode of the electric vehicle is a power supply mode, transmitting, by a controller, information of the electric vehicle to an energy storage system of a power supply place, receiving, by the controller, required power information, calculated based on the information of the electric vehicle, from the energy storage system, and controlling, by the controller, a charging and discharging device of the electric vehicle which discharges a battery of the electric vehicle so as to transmit required power corresponding to the required power information to the energy storage system of the power supply place.

### CROSS REFERENCE TO RELATED APPLICATIONS

This application claims priority to and the benefit of Korean Patent Application No. 10-2020-0168745 filed in the Korean Intellectual Property Office on Dec. 4, 2020, the entire contents of which are incorporated herein by reference.

### BACKGROUND

### (a) Field

The present disclosure relates to an electric vehicle, and more particularly, to a method and a device for supplying electric power of an electric vehicle.

### (b) Description of the Related Art

Electric vehicles are vehicles using not conventional fossil fuels but electric energy, and in recent years, related technologies have rapidly developed in response to the exhaust of fossil fuels and eco-friendly car development trend.

The electric vehicles use electricity as an energy source, and thus need to store and keep the electricity as the energy source. To this end, the electric vehicles need to charge a battery with general commercial electricity. In this case, a circuit used for charging a battery, which is an energy storage device of the electric vehicle, with commercial electricity having a high voltage is an on-board charger (OBC) circuit which is a charging circuit for the electric vehicle.

The OBC circuit is also called a slow charging circuit, and the OBC circuit converts the commercial electricity, which is an alternating current, into a direct current and charges the battery with the direct current, and in this case, the voltage stored in the battery is a high-voltage direct current supplied to a motor for driving the electric vehicle.

The above information disclosed in this Background section is only for enhancement of understanding of the background of the disclosure, and therefore it may contain information that does not form the prior art that is already known in this country to a person of ordinary skill in the art.

### SUMMARY

The present disclosure has been made in an effort to provide a method and a device for supplying electric power of an electric vehicle, which are capable of supplying the electric power to an energy storage system (ESS) which is a power source device of a power supply place (e.g., a camping site).

An exemplary embodiment of the present disclosure provides a method for supplying electric power of an electric vehicle, the method including when an operation mode of the electric vehicle is a power supply mode, transmitting, by a controller, information of the electric vehicle to an energy storage system of a power supply place, receiving, by the controller, required power information required by and calculated based on the information of the electric vehicle by the energy storage system of the power supply place, and controlling, by the controller, a charging and discharging device of the electric vehicle which discharges charging power of a battery of the electric vehicle so as to discharge required power corresponding to the required power information to the energy storage system of the power supply place.

The information of the electric vehicle may include positional information of the electric vehicle, state of charge (SOC) information of the battery of the electric vehicle, and suppliable power information of the electric vehicle.

The method may further include determining, by the controller, whether a state of charge (SOC) value of the battery that discharges the charging power is less than a reference value, and when the SOC value of the battery is less than the reference value, the controller may transmit discharge information of the battery for calculating a fee in the power supply place to the energy storage system of the power supply place.

The controller may receive, from the energy storage system of the power supply place, fee information of the power supply place except for a fee corresponding to a power supply amount corresponding to the discharge information of the battery.

The controller may settle the fee of the power supply place by using a settlement device which is included in the electric vehicle and stores credit card information therein.

Another exemplary embodiment of the present disclosure provides a device for supplying electric power of an electric vehicle, the device including a charging and discharging device configured to discharge a battery of an electric vehicle, and a controller configured to transmit information of the electric vehicle to an energy storage system of a power supply place when an operation mode of the electric vehicle is a power supply mode. The controller may receive required power information which is required by and calculated based on the information of the electric vehicle by the energy storage system of the power supply place, and the controller may control the charging and discharging device to discharge required power corresponding to the required power information to the energy storage system of the power supply place.

The information of the electric vehicle may include positional information of the electric vehicle, state of charge (SOC) information of the battery of the electric vehicle, and suppliable power information of the electric vehicle.

The controller may determine whether a state of charge (SOC) value of the battery that discharges the charging power is less than a reference value, and when the SOC value of the battery is less than the reference value, the controller may transmit discharge information of the battery for calculating a fee in the power supply place to the energy storage system of the power supply place.

The controller may receive, from the energy storage system of the power supply place, fee information of the power supply place except for a fee corresponding to a power supply amount corresponding to the discharge information of the battery.

The controller may settle the fee of the power supply place by using a settlement device which is included in the electric vehicle and stores credit card information therein.

According to exemplary embodiments of the present disclosure, the method and device for supplying electric power of an electric vehicle can supply the electric power to an energy storage system (ESS) which is a power source device of a power supply place (e.g., a camping site).

### BRIEF DESCRIPTION OF THE FIGURES

A brief description of each drawing is provided in order to help more sufficient understanding of drawings used in a detailed description of the present disclosure.

FIG. 1 is a flowchart for describing a method for supplying electric power of an electric vehicle according to an exemplary embodiment of the present disclosure.

FIG. 2 is a flowchart for describing an operation of an energy storage system (ESS) of a power supply place included in the method for supplying electric power of an electric vehicle, which is illustrated in FIG. 1.

FIG. 3 is a block diagram for describing a device for supplying electric power of an electric vehicle to which the method for supplying electric power of an electric vehicle, which is illustrated in FIG. 1 is applied.

### DETAILED DESCRIPTION

In order to sufficiently appreciate objects achieved by the present disclosure and exemplary embodiments of the present disclosure, accompanying drawings illustrating the exemplary embodiments of the present disclosure and contents disclosed in the accompanying drawings should be referred to.

Hereinafter, the present disclosure will be described in detail by describing the exemplary embodiments of the present disclosure with reference to the accompanying drawings. In the following description, a detailed explanation of related known configurations or functions may be omitted to avoid obscuring the subject matter of the present disclosure. Like reference numerals presented in each drawing may refer to like elements.

Terms used in the present specification are used only to describe specific exemplary embodiments, and are not intended to limit the present disclosure. An expression in a singular form may include an expression in a plural form unless otherwise clearly defined in the context. In the present specification, it should be understood that term “include” or “have” indicates that a feature, a number, a step, an operation, a component, a part or the combination thereof described in the specification is present, but does not exclude in advance a possibility of presence or addition of one or more other features, numbers, steps, operations, components, parts or combinations thereof.

Throughout the specification, when it is described that a part is “connected” with another part, it means not only that the parts are “directly connected” with each other but also that the parts are “electrically or mechanically connected” to each other with a still another element interposed therebetween.

Unless otherwise defined, all terms used herein including technological or scientific terms have the same meanings as those generally understood by those with ordinary skill in the art (those skilled in the art) to which the present disclosure pertains. Terms which are defined in a generally used dictionary should be interpreted to have the same meaning as the meaning in the context of the related art, and are not interpreted as an ideal meaning or excessively formal meanings unless clearly defined in the present specification.

In order to supply electric power to a camping car in a camping site, a power supply construction for connecting an electric power system to the camping site is required. Therefore, a fee or use cost of the camping site may rise.

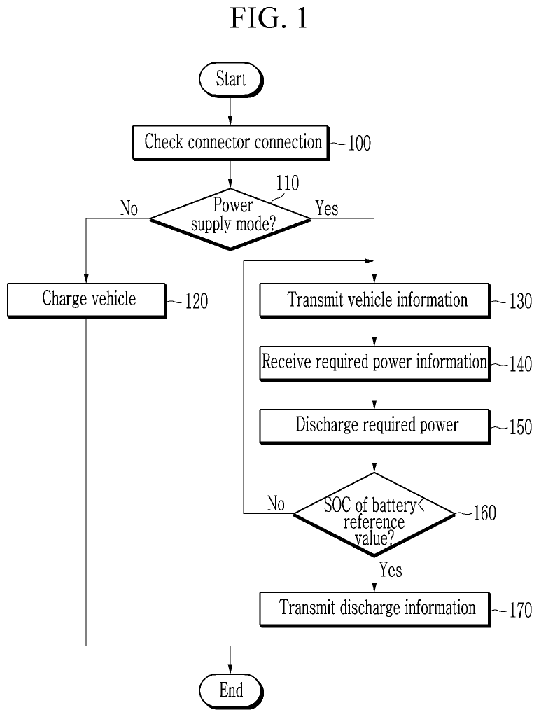

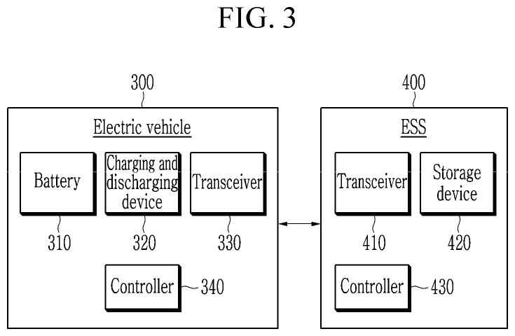

FIG. 1 is a flowchart for describing a method for supply electric power of an electric vehicle according to an exemplary embodiment of the present disclosure. FIG. 3 is a block diagram for describing a device for supplying electric power of an electric vehicle to which the method for supplying electric power of an electric vehicle, which is illustrated in FIG. 1 is applied.

Referring to FIGS. 1 and 3, in checking step 100, a controller 340 of an electric vehicle 300 may check whether a connector or a cable for transferring electric power of the electric vehicle 300 to an energy storage system (ESS) 400 of a power supply place, for example, a camping ground or site, is connected between the electric vehicle and the energy storage system. The power supply place may include a parking lot. The connector may transfer information of the electric vehicle 300 to the energy storage system 400 and transfer information of the energy storage system to the electric vehicle. The energy storage system 400 may supply the electric power to a vehicle in the power supply place.

As illustrated in FIG. 3, the electric vehicle (e.g., camping car) 300 may include a battery 310, a charging and discharging device 320 such as a bidirectional on-board charger (OBC), a transceiver 330, and the controller 340. The electric vehicle 300 may further include a driving motor such as an electric motor. The battery 310 is constituted by multiple unit cells, and may store a high voltage of, for example, direct current 350 to 450 V for providing a voltage to the driving motor that provides driving force to the electric vehicle.

A device for supplying electric power of the electric vehicle may include the battery 310, the charging and discharging device 320, the transceiver 330, and the controller 340.

The controller 340 as an electronic control unit (ECU) may control an overall operation of the electric vehicle 300. The controller 300 may be, for example, one or more microprocessors which operate by a program (control logic) or hardware (e.g., a microcomputer) including the microprocessors, and the program may include a series of instructions for performing the method for supplying electric power of an electric vehicle according to an exemplary embodiment of the present disclosure. The instructions may be stored in a memory of the electric vehicle 300 or the controller 340.

According to step 110 illustrated in FIG. 1, when the connector is connected between the electric vehicle 300 and the energy storage system 400, the controller 340 may determine whether an operation mode of the electric vehicle is a power supply mode (e.g., a vehicle to load (V2L) mode).

When the operation mode of the electric vehicle is not the power supply mode, the method for supplying electric power of the electric vehicle, which is a process, may proceed to step 120, and when the operation mode of the electric vehicle is the power supply mode, the power supplying method of the electric vehicle, which is the process, may proceed to step 130.

According to step 120, the controller 340 may control the charging and discharging device 320 so that the battery 310 of the electric vehicle 300 is charged with commercial electricity disposed outside the electric vehicle.

According to step 130, the controller 340 may transmit information of the electric vehicle 300 to the energy storage system 400 of the power supply place through the transceiver 330. The information of the electric vehicle 300 may include positional information of the electric vehicle, state of charge (SOC) information of the battery 310 of the electric vehicle, and suppliable power information of the electric vehicle.

According to step 140, the controller 340 may receive, through the transceiver 330, required power information required by the energy storage system 400 of the power supply place and calculated based on the information of the electric vehicle 300 by the energy storage system 400.

According to step 150, the controller 340 may control the charging and discharging device 320 of the electric vehicle 300, which discharges (transmits) charging power of the battery 300 so as to discharge or transmit required power (e.g., 10 KW) corresponding to the required power information to the energy storage system 400 of the power supply place. The charging and discharging device 320 may convert DC power of the battery 310 into AC power, and transmit the AC power to the energy storage system 400 of the power supply place.

According to step 160, the controller 340 may determine whether an SOC value of the battery 310 that discharges the charging power is less than a reference value. The reference value may be a minimum value among the SOC values of the battery 310 which enables the normal traveling of the electric vehicle 300, and may be determined by a test (or an experiment).

When the SOC value of the battery 310 is equal to or more than the reference value, the power supplying method of the electric vehicle, which is the process, may proceed to step 130, and when the SOC value of the battery 310 is less than the reference value, the power supplying method of the electric vehicle, which is the process, may proceed to step 170.

According to step 170, when the SOC value of the battery 310 is less than the reference value, the controller 340 may transmit discharge information of the battery for calculating a fee in the power supply place to the energy storage system 400 of the power supply place through the transceiver 400.

In another exemplary embodiment of the present disclosure, after step 170, the controller 340 may receive charge information of the power supply place, discounted by a fee corresponding to a power supply amount corresponding to the discharge information of the battery 310, from the energy storage system 400 of the power supply place. Further, the controller 340 may settle the fee in the power supply place by using a settlement device which is included in the electric vehicle 300 and stores credit card information therein.

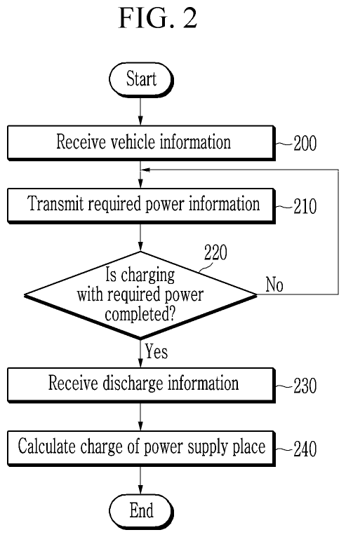

FIG. 2 is a flowchart for describing an operation of the energy storage system (ESS) of the power supply place, which is included in the method for supplying electric power of an electric vehicle, which is illustrated in FIG. 1.

Referring to FIGS. 2 and 3, in receiving step 200, a controller 430 of the energy storage system 400 of the power supply place may receive the information of the electric vehicle 300 from the electric vehicle through a transceiver 410.

The energy storage system 400 may include the transceiver 410, a storage device 420 such as the battery, and the controller 430.

The controller 430 as an electronic control unit (ECU) may control an overall operation of the energy storage system 400. The controller 430 may be, for example, one or more microprocessors which operate by a program or hardware (e.g., a microcomputer) including the microprocessors.

According to step 210, the controller 430 may calculate required power information of the energy storage system 400 based on the information of the electric vehicle 300 and transmit the calculated required power information to the electric vehicle 300 through the transceiver 410.

According to step 220, the controller 430 may determine whether the storage device 420 is completely charged with required power corresponding to the required power information. The storage device 420 may convert the AC power discharged from the charging and discharging device 320 into the DC power, and store the DC power in the storage device.

When the storage device 420 is not completely charged with the required power, the operation of the energy storage system 400 of the power supply place, which is the process, may proceed to step 210, and when the storage device 420 is completely charged with the required power, the operation of the energy storage system 400 of the power supply place, which is the process, may proceed to step 230.

According to step 230, the controller 430 may receive the discharge information of the battery 310 through the transceiver 410.

According to step 240, the controller 430 may calculate charge information of the power supply place except for a fee corresponding to a power supply amount corresponding to the discharge information of the battery 310 based on the discharge information of the battery 310.

In another exemplary embodiment of the present disclosure, after step 240, the controller 430 may receive settlement information for the fee in the power supply place from the electric vehicle 300 through the transceiver 410, and request settlement from a settlement processing server (e.g., a card settlement server) outside the energy storage system 400 of the power supply place by using a settlement request device of the energy storage system 400.

A component, “unit”, block or module used in the exemplary embodiment of the present disclosure may be implemented as software such as a task, a class, a sub routine, a process, an object, an execution thread, and a program performed in a predetermined area on the memory or hardware such as field programmable gate array (FPGA) or application-specific integrated circuit (ASIC), and further, may be achieved by a combination of the software and the hardware. The component, ‘unit’ or the like may be included in a computer readable storage medium, and some of the component, ‘unit’ or the like may be dispersedly distributed in a plurality of computers.

As described above, the embodiment is disclosed in the drawings and the specification. Although specific terms have been used herein, the terms are only used for the purpose of describing the present disclosure and are not used to limit the meaning thereof or the scope of the present disclosure as defined in the claims. Therefore, those skilled in the art will appreciate that various modifications and equivalent embodiments can be made from the present disclosure. Accordingly, the true technical scope of the present disclosure should be defined by the technical spirit of the appended claims.

1. A method for supplying electric power of an electric vehicle, the method comprising:
when an operation mode of the electric vehicle is a power supply mode, transmitting, by a controller, information of the electric vehicle to an energy storage system of a power supply place;
receiving, by the controller, required power information, calculated based on the information of the electric vehicle, from the energy storage system; and
controlling, by the controller, a charging and discharging device of the electric vehicle which discharges charging power of a battery of the electric vehicle so as to transmit required power corresponding to the required power information to the energy storage system of the power supply place.

2. The method of claim 1, wherein:
the information of the electric vehicle includes positional information of the electric vehicle, state of charge (SOC) information of the battery of the electric vehicle, and suppliable power information of the electric vehicle.

3. The method of claim 1, further comprising:
determining, by the controller, whether a state of charge (SOC) value of the battery that discharges the charging power is less than a reference value, wherein when the SOC value of the battery is less than the reference value, the controller transmits discharge information of the battery for calculating a fee in the power supply place to the energy storage system of the power supply place.

4. The method of claim 3, wherein the controller receives, from the energy storage system of the power supply place, fee information of the power supply place except for a fee corresponding to a power supply amount corresponding to the discharge information of the battery.

5. The method of claim 4, wherein the controller settles the fee in the power supply place by using a settlement device which is included in the electric vehicle and stores credit card information therein.

6. A device for supplying electric power of an electric vehicle, the device comprising:
a charging and discharging device configured to discharge a battery of an electric vehicle; and
a controller configured to transmit information of the electric vehicle to an energy storage system of a power supply place when an operation mode of the electric vehicle is a power supply mode;
wherein the controller receives, from the energy storage system, required power information calculated based on the information of the electric vehicle; and
wherein the controller controls the charging and discharging device to transmit required power, corresponding to the required power information, to the energy storage system of the power supply place.

7. The device of claim 6, wherein:
the information of the electric vehicle includes positional information of the electric vehicle, state of charge (SOC) information of the battery of the electric vehicle, and suppliable power information of the electric vehicle.

8. The device of claim 6, wherein:
the controller determines whether a state of charge (SOC) value of the battery that discharges the charging power is less than a reference value, and
when the SOC value of the battery is less than the reference value, the controller transmits discharge information of the battery for calculating a fee in the power supply place to the energy storage system of the power supply place.

9. The device of claim 8, wherein the controller receives, from the energy storage system of the power supply place, fee information of the power supply place except for a fee corresponding to a power supply amount corresponding to the discharge information of the battery.

10. The device of claim 9, wherein the controller settles the fee of the power supply place by using a settlement device which is included in the electric vehicle and stores credit card information therein.
